(19) United States
(12) Patent Application Publication
(10) Pub. No.: US 2025/0227741 A1
(43) Pub. Date: Jul. 10, 2025

(54) Low Latency Session Setup and Use

(71) Applicant: Apple Inc., Cupertino, CA (US)

(72) Inventors: Mohamed Abouelseoud, Burlingame, CA (US); Jinjing Jiang, Campbell, CA (US); Jarkko L. Kneckt, Los Gatos, CA (US); Morteza Mehrnoush, Hayward, CA (US); Yong Liu, Campbell, CA (US); Oren Shani, Saratoga, CA (US); Anuj Batra, Redwood City, CA (US)

(21) Appl. No.: 18/991,205

(22) Filed: Dec. 20, 2024

Related U.S. Application Data
(60) Provisional application No. 63/619,109, filed on Jan. 9, 2024.

(51) Int. Cl. H04W 72/512; H04W 28/02; H04W 74/08

(52) U.S. Cl. CPC H04W 72/512; H04W 28/0268; H04W 74/08

(57) ABSTRACT

This disclosure relates to methods for low latency session setup and use in a wireless local area network. A pair of wireless devices may perform low latency session setup that establishes one or more low latency session parameters for a low latency session between the wireless devices. During the low latency session, a low latency traffic indication may be provided in a non-low latency data frame and control response frame exchange, which may be used to indicate whether the wireless device receiving the non-low latency data frame has a low latency request.

### PRIORITY INFORMATION

This application claims priority to U.S. provisional patent application Ser. No. 63/619,109, entitled “Low Latency Session Setup and Use,” filed Jan. 9, 2024, which is hereby incorporated by reference in its entirety as though fully and completely set forth herein.

### TECHNICAL FIELD

The present application relates to wireless communication, including techniques and devices for setting up, using, and tearing down a low latency session in a wireless local area network.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs) may take the form of smart phones or tablets that a user typically carries. One aspect of wireless communication that may commonly be performed by mobile devices may include wireless networking, for example over a wireless local area network (WLAN), which may include devices that operate according to one or more communication standards in the IEEE 802.11 family of standards. In a wireless local area network, it may be possible that certain traffic can be delayed while other communications in the network are being performed. This can potentially cause performance degradation for traffic for which low latency is important, at least in some instances. Accordingly, improvements in the field are desired.

### SUMMARY

Embodiments are presented herein of, inter alia, systems, apparatuses, and methods for devices to set up, use, and tear down a low latency session in a wireless local area network.

A wireless device may include one or more antennas, one or more radios operably coupled to the one or more antennas, and a processor operably coupled to the one or more radios. The wireless device may be configured to establish a connection with an access point through a wireless local area network (WLAN) over one or multiple wireless links, or may be an access point configured to establish a connection with one or more other wireless devices through a WLAN over one or multiple wireless links. The wireless device may operate in each of the multiple wireless links using a respective radio of the one or more radios.

According to the techniques described herein, wireless devices may establish low latency sessions with low latency session parameters configured to support latency sensitive stream requirements. The low latency session parameters may include parameters that limit the target length of non-low latency data frames, which may allow more frequent opportunities for low latency frames to be transmitted. Additionally, or alternatively, the low latency session parameters may support preemption of a transmit opportunity that is being used for non-low latency communication to perform low latency communication. Once the low latency session is no longer desired, it may be the case that any wireless device in the low latency session can tear down the low latency session.

The techniques described herein may be implemented in and/or used with a number of different types of devices, including but not limited to cellular phones, tablet computers, accessory and/or wearable computing devices, portable media players, access point devices, base stations and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a flowchart diagram illustrating an example method for establishing, using, and tearing down a low latency session in a wireless local area network, according to some embodiments;

FIGS. 5-6 illustrate example scenarios in which TX shortening may occur, including a PPDU bursting example and a TXOP duration limiting example, according to some embodiments;

FIG. 7 illustrates example aspects of a scenario in which a STA is subject to a channel access delay while waiting for TXOP completion, according to some embodiments;

FIG. 8 is a timing diagram illustrating example aspects of possible low latency session setup and teardown, according to some embodiments;

FIG. 9 is a signal flow diagram illustrating example aspects of possible low latency session setup and teardown communication, according to some embodiments;

FIG. 10 illustrates example aspects of a low latency session scenario in which a TXOP initiator preempts its own TXOP to transmit low latency data to a TXOP responder, according to some embodiments;

FIG. 11 illustrates aspects of an example low latency session scenario in which a TXOP bursts are each limited to one PPDU, according to some embodiments;

FIG. 12 illustrates example aspects of a possible low latency session scenario in which a TXOP is shared by a TXOP initiator with a TXOP responder to allow the TXOP responder to transmit low latency data to the TXOP initiator, according to some embodiments;

FIGS. 13-16 illustrate examples of possible low latency session feature usage during uplink communication scenarios, according to various embodiments;

FIGS. 17-20 illustrate examples of possible low latency session feature usage during downlink communication scenarios, according to various embodiments;

FIGS. 21-23 illustrate example aspects of possible low latency session scenarios in which a TXOP initiator can choose to reject a preemption request from a TXOP responder, according to some embodiments;

FIGS. 24-25 illustrate example aspects of possible low latency session scenarios in which a STA requests TXOP disengagement, according to some embodiments;

FIGS. 26-28 illustrate example aspects of possible low latency session scenarios in which TXOP preemption for P2P communication is used, according to some embodiments;

FIG. 29 illustrates example aspects of a possible low latency session scenario in which TXOP preemption occurs at the beginning of the TXOP, according to some embodiments;

FIGS. 30-31 illustrate example aspects of possible low latency session scenarios in which BA feedback is not received, according to some embodiments;

FIG. 32 illustrates example aspects of one possible update to a BA frame format to support low latency feedback in a low latency session, according to some embodiments;

FIGS. 33-34 illustrate example aspects of a possible multi-STA BA frame that could be used to support low latency feedback in a low latency session, according to some embodiments; and

FIGS. 35-38 illustrate example aspects of possible low latency session setup and teardown frame element formats, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium—Any of various types of non-transitory memory devices or storage devices. The term “memory medium” is intended to include any computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), portable gaming devices, laptops, wearable devices (e.g., smart watch, smart glasses), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile) or may be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station or Access Point (AP)—The term “Base Station” (also called “eNB” or “gNB”) has the full breadth of its ordinary meaning, and at least includes a wireless communication station installed at a fixed location and used to communicate as part of a wireless communication system. The term “access point” (or “AP”) is typically associated with Wi-Fi based communications and is used similarly.

Processing Element (or Processor)—refers to various elements or combinations of elements that are capable of performing a function in a device, e.g., in a communication device or in a network infrastructure device. Processors may include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11—refers to technology based on IEEE 802.11 wireless standards such as 802.11a, 802.11.b, 802.11g, 802.11n, 802.11-2012, 802.11ac, 802.11ad, 802.11ax, 802.1lay, 802.11be, and/or other IEEE 802.11 standards. IEEE 802.11 technology may also be referred to as “Wi-Fi” or “wireless local area network (WLAN)” technology.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

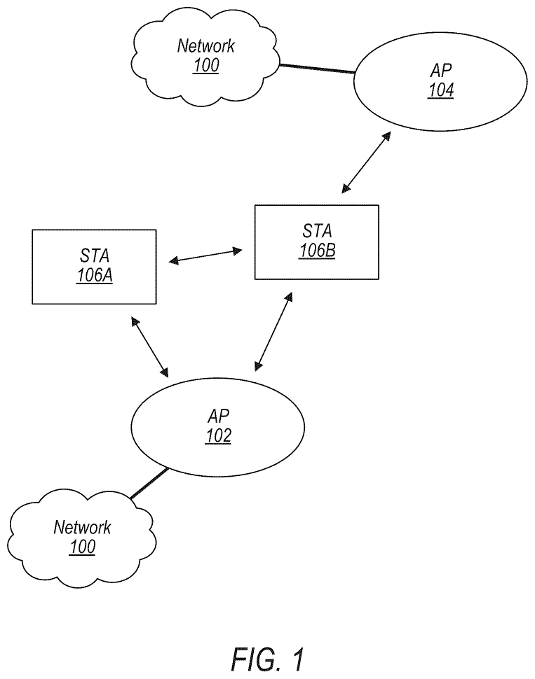

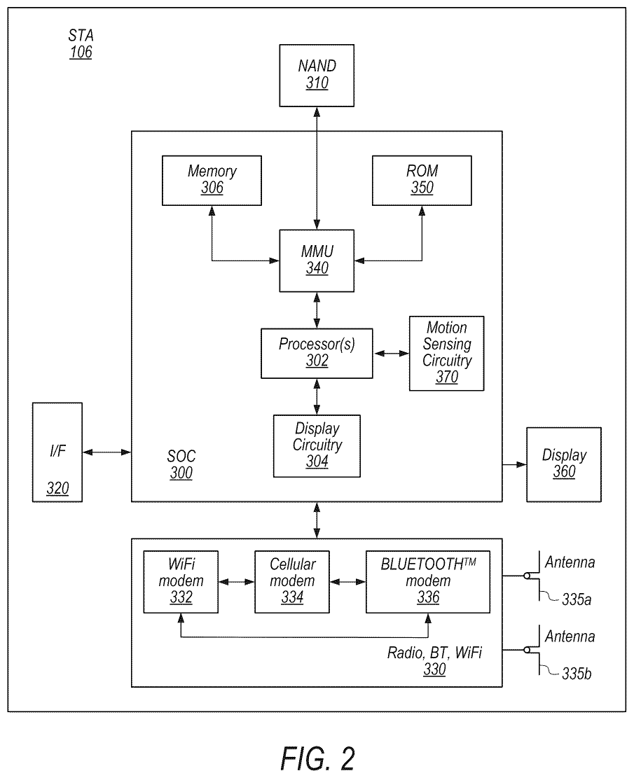

### FIGS. 1-2—Wireless Communication System

FIG. 1 illustrates an example of a wireless communication system. It is noted that FIG. 1 represents one possibility among many, and that features of the present disclosure may be implemented in any of various systems, as desired. For example, embodiments described herein may be implemented in any type of wireless device. The wireless embodiment described below is one example embodiment.

As shown, the exemplary wireless communication system includes an access point (AP) 102, which communicates over a transmission medium with one or more wireless devices 106A, 106B, etc. Wireless devices 106A and 106B may be user devices, such as stations (STAs), non-AP STAs, or WLAN devices.

The STA 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The STA 106 may include a processor (processing element) that is configured to execute program instructions stored in memory. The STA 106 may perform any of the method embodiments described herein by executing such stored instructions. Alternatively, or in addition, the STA 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

The AP 102 may be a stand-alone AP or an enterprise AP, and may include hardware that enables wireless communication with the STA devices 106A and 106B. The AP 102 may also be equipped to communicate with a network 100 (e.g., a WLAN, an enterprise network, and/or another communication network connected to the Internet, among various possibilities). Thus, the AP 102 may facilitate communication among the STA devices 106 and/or between the STA devices 106 and the network 100. In other implementations, AP 102 can be configured to provide communications over one or more wireless technologies, such as any, any combination of, or all of 802.11 a, b, g, n, ac, ad, ax, ay, be and/or other 802.11 versions, or a cellular protocol, such as 5G or LTE, including in an unlicensed band (e.g., LAA, NR-U).

The communication area (or coverage area) of the AP 102 may be referred to as a basic service area (BSA) or cell. The AP 102 and the STAs 106 may be configured to communicate over the transmission medium using any of various radio access technologies (RATs) or wireless communication technologies, such as Wi-Fi, LTE, LTE-Advanced (LTE-A), 5G NR, ultra-wideband (UWB), etc.

AP 102 and other similar access points (not shown) operating according to one or more wireless communication technologies may thus be provided as a network, which may provide continuous or nearly continuous overlapping service to STA devices 106A-B and similar devices over a geographic area, e.g., via one or more communication technologies. A STA may roam from one AP to another directly, or may transition between APs and cellular network cells.

Note that at least in some instances a STA device 106 may be capable of communicating using any of multiple wireless communication technologies. For example, a STA device 106 might be configured to communicate using one or more of Wi-Fi, LTE, LTE-A, 5G NR, Bluetooth, UWB, one or more satellite systems, etc. Other combinations of wireless communication technologies (including more than two wireless communication technologies) are also possible. Likewise, in some instances a STA device 106 may be configured to communicate using only a single wireless communication technology.

As shown, the exemplary wireless communication system also can include an access point (AP) 104, which communicates over a transmission medium with the wireless device 106B. The AP 104 also provides communicative connectivity to the network 100. Thus, according to some embodiments, wireless devices may be able to connect to either or both of the AP 102 (or a cellular base station) and the access point 104 (or another access point) to access the network 100. For example, a STA may roam from AP 102 to AP 104 based on one or more factors, such as coverage, interference, and capabilities. Note that it may also be possible for the AP 104 to provide access to a different network (e.g., an enterprise Wi-Fi network, a home Wi-Fi network, etc.) than the network to which the AP 102 provides access.

The STAs 106A and 106B may include handheld devices such as smart phones or tablets, wearable devices such as smart watches or smart glasses, and/or may include any of various types of devices with cellular communications capability. For example, one or more of the STAs 106A and/or 106B may be a wireless device intended for stationary or nomadic deployment such as an appliance, measurement device, control device, etc.

The STA 106B may also be configured to communicate with the STA 106A. For example, the STA 106A and STA 106B may be capable of performing direct device-to-device (D2D) communication. In some embodiments, such direct communication between STAs may also or alternatively be referred to as peer-to-peer (P2P) communication. The direct communication may be supported by the AP 102 (e.g., the AP 102 may facilitate discovery, among various possible forms of assistance), or may be performed in a manner unsupported by the AP 102. Such P2P communication may be performed using 3GPP-based D2D communication techniques, Wi-Fi based P2P communication techniques, UWB, BT, and/or any of various other direct communication techniques, according to various embodiments.

The STA 106 may include one or more devices or integrated circuits for facilitating wireless communication, potentially including a Wi-Fi modem, cellular modem and/or one or more other wireless modems. The wireless modem(s) may include one or more processors (processor elements) and various hardware components as described herein. The STA 106 may perform any of (or any portion of) the method embodiments described herein by executing instructions on one or more programmable processors. For example, the STA 106 may be configured to perform techniques for setting up, using, and/or tearing down a low latency session in a wireless communication system, such as according to the various embodiments described herein. Alternatively, or in addition, the one or more processors may be one or more programmable hardware elements such as an FPGA (field-programmable gate array), application-specific integrated circuit (ASIC), or other circuitry, that is configured to perform any of the method embodiments described herein, or any portion of any of the method embodiments described herein. The wireless modem(s) described herein may be used in a STA device as defined herein, a wireless device as defined herein, or a communication device as defined herein. The wireless modem described herein may also be used in an AP, a base station, a pico cell, a femto cell, or other similar network side device.

The STA 106 may include one or more antennas for communicating using two or more wireless communication protocols or radio access technologies. In some embodiments, the STA 106 can be configured to communicate using a single shared radio. The shared radio may couple to a single antenna, or may couple to multiple antennas (e.g., for MIMO) for performing wireless communications. Alternatively, the STA 106 may include two or more radios, each of which may be configured to communicate via a respective wireless link. Other configurations are also possible.

### FIG. 2—Example Block Diagram of a STA Device

FIG. 2 illustrates one possible block diagram of a STA device, such as STA device 106. In some instances, the STA 106 may alternatively be referred to as a UE 106. STA 106 also may be referred to as a non-AP STA 106. As shown, the STA 106 may include a system on chip (SOC) 300, which may include one or more portions configured for various purposes. Some or all of the various illustrated components (and/or other device components not illustrated, e.g., in variations and alternative arrangements) may be “communicatively coupled” or “operatively coupled,” which terms may be taken herein to mean components that can communicate, directly or indirectly, when the device is in operation.

As shown, the SOC 300 may include processor(s) 302 which may execute program instructions for the STA 106, and display circuitry 304 which may perform graphics processing and provide display signals to the display 360. The SOC 300 may also include motion sensing circuitry 370 which may detect motion of the STA 106, for example using a gyroscope, accelerometer, and/or any of various other motion sensing components. The processor(s) 302 may also be coupled to memory management unit (MMU) 340, which may be configured to receive addresses from the processor(s) 302 and translate those addresses to locations in memory (e.g., memory 306, read only memory (ROM) 350, flash memory 310). The MMU 340 may be configured to perform memory protection and page table translation or set up. In some embodiments, the MMU 340 may be included as a portion of the processor(s) 302.

As shown, the SOC 300 may be coupled to various other circuits of the STA 106. For example, the STA 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, 5G NR, Bluetooth, Wi-Fi, NFC, GPS, UWB, etc.).

The STA 106 may include at least one antenna, and in some embodiments multiple antennas 335a and 335b, for performing wireless communication with base stations and/or other devices. For example, the STA 106 may use antennas 335a and 335b to perform the wireless communication. As noted above, the STA 106 may in some embodiments be configured to communicate wirelessly using a plurality of wireless communication standards or radio access technologies (RATs).

The wireless communication circuitry 330 may include a Wi-Fi modem 332, a cellular modem 334, and a Bluetooth modem 336. The Wi-Fi modem 332 is for enabling the STA 106 to perform Wi-Fi or other WLAN communications on an 802.11 network. The Bluetooth modem 336 is for enabling the STA 106 to perform Bluetooth communications. The cellular modem 334 may be a cellular modem capable of performing cellular communication according to one or more cellular communication technologies, e.g., in accordance with one or more 3GPP specifications.

As described herein, STA 106 may include hardware and software components for implementing embodiments of this disclosure. For example, one or more components of the wireless communication circuitry 330 (e.g., Wi-Fi modem 332, cellular modem 334, BT modem 336) of the STA 106 may be configured to implement part or all of the methods for low latency session setup and use described herein, e.g., by a processor executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit).

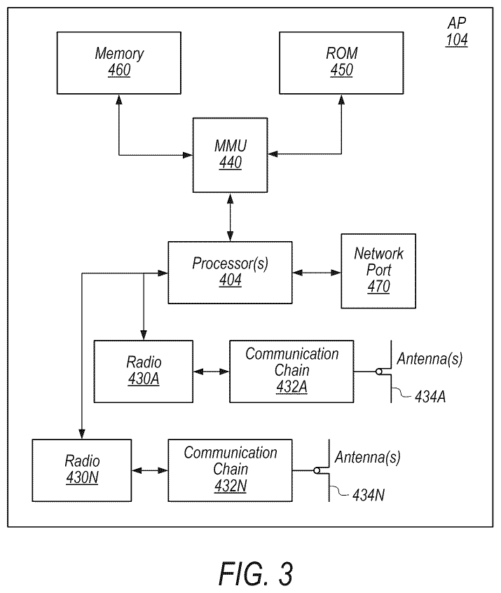

### FIG. 3—Block Diagram of an Access Point

FIG. 3 illustrates an example block diagram of an access point (AP) 104, according to some embodiments. In some instances (e.g., in an 802.11 communication context), the AP 104 may also be referred to as a station (STA), and possibly more particularly as an AP STA. It is noted that the AP of FIG. 3 is merely one example of a possible access point. As shown, AP 104 may include processor(s) 404 which may execute program instructions for the AP 104. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The AP 104 may include at least one network port 470. The network port 470 may be configured to couple to a telephone network and provide a plurality of devices, such as STA devices 106, with access to the telephone network as described above in FIG. 1.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The AP 104 may include one or more radios 430A-430N, each of which may be coupled to a respective communication chain and at least one antenna 434, and possibly multiple antennas. The antenna(s) 434 may be configured to operate as a wireless transceiver and may be further configured to communicate with UE devices 106/107 via radio 430. The antenna(s) 434A-N communicate with their respective radios 430A-N via communication chains 432A-N. Communication chains 432 may be receive chains, transmit chains, or both. The radios 430A-N may be configured to communicate in accordance with various wireless communication standards, including, but not limited to, LTE, LTE-A, 5G NR, UWB, Wi-Fi, BT, etc. The AP 104 may be configured to operate on multiple wireless links using the one or more radios 430A-N, wherein each radio is used to operate on a respective wireless link.

The AP 104 may be configured to communicate wirelessly using multiple wireless communication standards. In some instances, the AP 104 may include multiple radios, which may enable the network entity to communicate according to multiple wireless communication technologies. For example, as one possibility, the AP 104 may include a 4G or 5G radio for performing communication according to a 3GPP wireless communication technology as well as a Wi-Fi radio for performing communication according to Wi-Fi. In such a case, the AP 104 may be capable of operating as both a cellular base station and a Wi-Fi access point. As another possibility, the AP 104 may include a multi-mode radio which is capable of performing communications according to any of multiple wireless communication technologies (e.g., 5G NR and Wi-Fi, 5G NR and LTE, etc.). As still another possibility, the AP 104 may be configured to act exclusively as a Wi-Fi access point, e.g., without cellular communication capability.

As described further herein, the AP 104 may include hardware and software components for implementing or supporting implementation of features described herein, such as setting up, using, and tearing down a low latency session in a wireless communication system. The processor 404 of the AP 104 may be configured to implement or support implementation of part or all of the methods described herein, e.g., by executing program instructions stored on a memory medium (e.g., a non-transitory computer-readable memory medium) to operate multiple wireless links using multiple respective radios. Alternatively, the processor 404 may be configured as a programmable hardware element, such as an FPGA (Field Programmable Gate Array), or ASIC (Application Specific Integrated Circuit), or a combination thereof. Alternatively (or in addition) the processor 404 of the AP 104, in conjunction with one or more of the other components 430, 432, 434, 440, 450, 460, 470 may be configured to implement or support implementation of part or all of the features described herein.

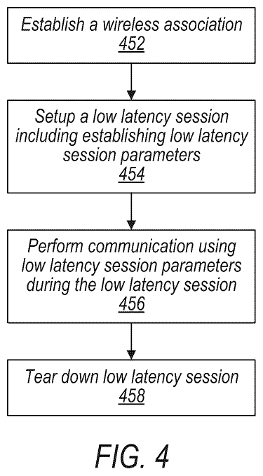

### FIG. 4—Low Latency Session Setup, Use, and Teardown

FIG. 4 is a flowchart diagram illustrating a method for supporting low latency session set up, use, and tear down in a WLAN, according to some embodiments. In various embodiments, some of the elements of the methods shown may be performed concurrently, in a different order than shown, may be substituted for by other method elements, or may be omitted. Additional method elements may also be performed as desired.

Aspects of the method of FIG. 4 may be implemented by a wireless device, such as the AP 104 or STA 106 illustrated in and described with respect to FIGS. 1-3, or more generally in conjunction with any of the computer circuitry, systems, devices, elements, or components shown in the Figures, among others, as desired. For example, a processor (and/or other hardware) of such a device may be configured to cause the device to perform any combination of the illustrated method elements and/or other method elements.

Note that while at least some elements of the method of FIG. 4 are described in a manner relating to the use of communication techniques and/or features associated with IEEE 802.11 specification documents, such description is not intended to be limiting to the disclosure, and aspects of the method of FIG. 4 may be used in any suitable wireless communication system, as desired. As shown, the method may operate as follows.

At least two wireless devices may establish a wireless association (452). The wireless association may be established using Wi-Fi, wireless communication techniques that are based at least in part on Wi-Fi, and/or any of various other wireless communication technologies, according to various embodiments. For example, an access point (AP) wireless device may provide beacon transmissions including information for associating with the AP wireless device, and one or more other wireless devices (e.g., non-AP wireless devices) may request to associate with the AP wireless device using the information provided in the beacon transmissions, as one possibility. Such an association may also be referred to as an infrastructure link. As another example, two peer wireless devices could perform signaling to establish a peer-to-peer (P2P) communication session. Such an association may also be referred to as a P2P link. Variations and/or other techniques for establishing an association are also possible.

The wireless association may be used by the associated wireless devices to perform wireless local area network communication among the associated wireless devices, at least according to some embodiments. As part of the wireless local area network functionality, it may be possible for wireless devices to contend for medium access and perform wireless transmissions on one or more wireless communication channels (each of which could possibly include multiple sub-channels) according to general provisions of the wireless communication technology in use by the wireless local area network (e.g., Wi-Fi, as one possibility) and/or network specific parameters configured by the AP wireless device or negotiated by the peer devices. For example, in some embodiments, data transmission may include contending for medium access (e.g., to avoid collisions and potential interference), and, once medium access is obtained, transmitting a physical layer (PHY) protocol data unit (PPDU) (which may also be referred to as an uplink frame or a downlink frame depending on the traffic direction) to the destination wireless device. The frame may include physical layer signaling (e.g., including a preamble for frame detection, timing and frequency synchronization, channel estimation, etc., and header information indicating packet configuration, format, data rates, channel occupation time, and/or other control information) and data (which may in turn include one or more higher layer packets, such as media access control (MAC) protocol data units (MPDUs).

The wireless devices (which may be referred to as a “first wireless device” and a “second wireless device” for ease of understanding) may set up a low latency session (454). Performing low latency session setup may include establishing one or more low latency session parameters for the low latency session between the first wireless device and the second wireless device. For example, a low latency session setup request and response exchange may be performed by the first wireless device and the second wireless device. The low latency session setup request may be transmitted by either of the first or the second wireless device, and may indicate the desired parameters for the low latency session. The low latency session setup response may be transmitted by the other of the first or the second wireless device, and may indicate whether the low latency session setup request is accepted or rejected. Thus, the first wireless device may transmit the low latency session setup request to the second wireless device, and receive the low latency session setup response from the second wireless device, or the first wireless device may receive the low latency session setup request from the second wireless device, and transmit the low latency session setup response to the second wireless device, according to various embodiments.

In case the low latency session setup request is rejected, it may be possible that the low latency session setup response indicates one or more suggested low latency session parameters that differ from one or more low latency session parameters indicated in the low latency session setup request. In such a scenario, the initiator of the low latency session setup request may follow up with a second low latency session setup request, which may indicate different desired parameters for the low latency session than the first low latency session setup request, that may for example be selected based at least in part on the low latency session parameters suggested by the low latency session setup response (e.g., to match the suggested parameters, or otherwise based on the suggested parameters). Multiple such exchanges can occur between the wireless devices to negotiate an acceptable set of low latency session parameters, if desired. Alternatively, it may be possible that no low latency session setup is established, e.g., if no agreement can be made between the wireless devices on the low latency session parameters.

The low latency session parameters may include any of a variety of possible parameters. One possible aspect of the low latency session parameters could include a set of one or more traffic identifiers (TIDs) that are configured as latency sensitive traffic streams for the low latency session for one or more of downlink or uplink traffic directions. The TID(s) that are configured as latency sensitive traffic streams could be the same for both traffic directions, or could be different for the downlink and uplink traffic directions, according to various embodiments. The designation of one or more TIDs and traffic directions as latency sensitive and one or more other TIDs and traffic directions as non-latency sensitive may be used to determine whether transmit opportunity (TXOP) preemption can be performed during the low latency session by the wireless devices establishing the low latency session, at least according to some embodiments. For example, arrival of low latency data (e.g., data that is associated with a TID that is configured as a latency sensitive traffic stream for a given traffic direction) may provide basis for a wireless device to preempt a TXOP that is being used for non-low latency data (e.g., data that is associated with a TID that is not configured as a latency sensitive traffic stream for a given traffic direction) during the low latency session, at least in some instances.

Another possible aspect of the low latency session parameters could include a target physical layer protocol data unit (PPDU) length limit for non-low latency traffic during the low latency session. Such a target limit may be used to prevent the wireless devices participating in the low latency session from transmitting longer non-low latency PPDUs than the target PPDU limit, for example so that opportunities for preempting a TXOP for latency sensitive data communication are available with sufficient frequency to meet the latency requirements of latency sensitive data, at least according to some embodiments.

Yet another possible aspect of the low latency session parameters could include whether PPDU bursting during a TXOP is enabled or disabled during the low latency session. Such a parameter may provide additional control over how often medium contention and/or TXOP preemption opportunities are available during the low latency session, at least according to some embodiments.

Once the low latency session setup is complete, the wireless devices may perform data communication using the low latency session parameters during the low latency session (456). Such communication could include a non-low latency data frame and control response frame exchange, as one possibility. In such a scenario, the length of the non-low latency data frame may be determined based at least in part on the target PPDU length limit for non-low latency traffic during the low latency session. Additionally, or alternatively, the control response frame may include a low latency traffic indication, which may indicate whether the device transmitting the control response frame has a low latency request. As another possibility, it can be the case that TXOP preemption/sharing at the beginning of the TXOP is possible. For example, an initial control frame (e.g., block acknowledgement request (BAR) frame, Quality of Service (QOS) Null frame, multi-user request to send (MU-RTS) frame, buffer status report poll (BSRP), etc.) could be used to solicit a BA or other control response frame that can include a low latency request or other preemption indication.

The low latency traffic indication may be used to indicate any of multiple possible meanings, according to some embodiments. For example, various values of a low latency traffic indication field may be possible, with each such value having a defined meaning. The low latency traffic indication could, for example, indicate any of: a request to transmit low latency traffic to a wireless device that is a TXOP initiator in the TXOP; a request to transmit low latency traffic to a wireless device that is not the TXOP initiator in the TXOP; a request to disengage from the TXOP; a request for an amount of time of the TXOP; or no low latency request. Other types of low latency traffic indications may additionally or alternatively be possible, as desired.

The low latency traffic indication could be provided in a BA frame, a multi-station (M-STA) BA frame, or another type of control response frame, according to various embodiments. For example, certain reserved bits of an existing BA frame format could be defined for use for providing a low latency traffic indication, a variant of an existing BA frame format (such as M-STA BA, as one example) could be used, or a new type of BA frame format could be defined that includes one or more fields or sub-fields for providing a low latency traffic indication, according to various embodiments.

The TXOP initiator (e.g., either the first wireless device or the second wireless device, according to various possible scenarios) may determine whether to heed the low latency traffic indication. For example, the TXOP initiator may determine to continue the TXOP, or share the TXOP, or terminate the TXOP, based at least in part on the low latency traffic indication. In case the TXOP is shared, a control frame indicating that the TXOP is shared may be transmitted to the TXOP responder. The TXOP responder may perform a low latency communication (e.g., transmitting a low latency data frame to the TXOP initiator or another wireless device) during the shared TXOP. If there is any duration remaining in the TXOP, the TXOP responder may transmit a control frame to the TXOP initiator to return the TXOP to the TXOP initiator after performing the low latency communication (e.g., after the duration of the TXOP that is shared with the TXOP responder).

In case the TXOP is terminated, a control frame indicating that the TXOP is being terminated may be transmitted to the TXOP responder, or possibly the TXOP initiator may release the wireless medium without transmitting any such control frame. Termination of the TXOP may allow the TXOP responder or another device contending for the wireless medium to initiate a new TXOP, which may facilitate a low latency communication including one of the wireless devices in the low latency session. For example, if the TXOP responder is expecting to receive low latency data from another device, requesting that the TXOP be terminated to allow that other device to try to obtain medium access to transmit the low latency transmission may be useful.

If the TXOP responder provides a request to disengage from the TXOP using the low latency traffic indication, it may be the case that the TXOP initiator can continue the TXOP without the TXOP responder. For example, the TXOP initiator may transmit one or more SU or MU PPDUs to other wireless devices. At least in some instances, the TXOP responder may use such an indication if the TXOP responder is expecting to transmit or receive low latency data with another device on another link.

The low latency session may, at a later time, be torn down (458). According to some embodiments, it may be possible for either wireless device in the low latency session to tear down the low latency session. For example, either the first wireless device could transmit a low latency session teardown message to the second wireless device, or the second wireless device could transmit a low latency session teardown message to the first wireless device. Thus, it may be the case that low latency session teardown can be unilaterally decided upon and indicated by either side. Once the low latency session is finished, the wireless devices may no longer be bound by the low latency session parameters, at least in some embodiments.

Note that a wireless device may be able to be in multiple low latency sessions at the same time. For example, it may be possible for an AP wireless device to be in a low latency session with multiple non-AP wireless devices associated with the AP wireless device, or for a non-AP wireless device to be in a low latency session with an AP wireless device with which it is associated as well as with a peer wireless device. In such scenarios, it may be the case that the lowest target PPDU length limit among the active low latency sessions for the wireless devices is used when selecting target PPDU length for non-low latency traffic if the PPDU is to be transmitted to all those wireless devices (during multi-user transmission for example), at least according to some embodiments. Similarly for other low latency session parameters, it may be the case that the minimum requirements all of the low latency sessions are considered in determining wireless device behavior.

Thus, according to the method of FIG. 4, it may be possible to setup a low latency session with low latency session parameters that support preemption of non-low latency transmit opportunities in favor of low latency communications, including for a variety of scenarios regarding whether the preempting-and preempted communications are for uplink or downlink traffic directions and/or on infrastructure or P2P links. Such techniques may provide improved latency for targeted traffic types, and/or provide any of a variety of other possible benefits, at least according to some embodiments.

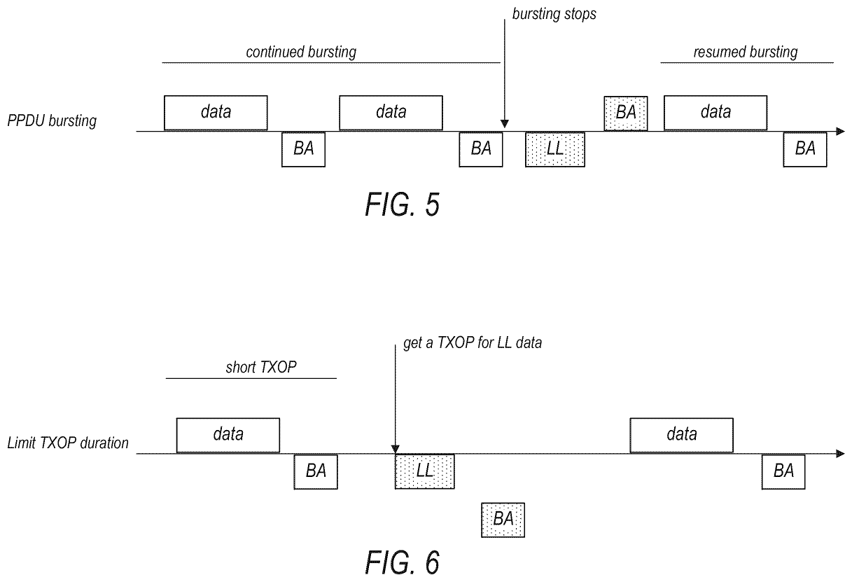

### FIGS. 5-38 and Additional Information

FIGS. 5-38 illustrate further aspects that might be used in conjunction with the method of FIG. 4 if desired. It should be noted, however, that the exemplary details illustrated in and described with respect to FIGS. 5-38 are not intended to be limiting to the disclosure as a whole: numerous variations and alternatives to the details provided herein below are possible and should be considered within the scope of the disclosure.

In a Wi-Fi based communication setting, it may be possible that a client station (STA) only supports 5/6 GHz single link operation, while its associated access point (AP) supports simultaneous transmit and receive (STR) with both 5 and 6 GHz links. Low latency applications in this example scenario may have a delay bound as low as ≤2 ms. If the client in this scenario is confined to use the current link to service the application, under various circumstances, it may be beneficial to provide techniques to better support the client STA's uplink (UL), downlink (DL), and peer-to-peer (P2P) low latency traffic.

In some instances, it may be possible that an over-the-air (OTA) transmission of a physical layer protocol data unit (PPDU) could be approximately 5.4 ms. A long TXOP may possibly be even longer. To be able to meet a ≤2 ms delay bound, then, it may be helpful if such a long PPDU can or is required to be “broken short” or “ended earlier” such that the low latency data can be transmitted. In the discussion here, methods of breaking short or ending a long PPDU early may also be referred to as “shorten TX,” or “TX shortening” e.g., in the sense that it may facilitate the possibility that the other STAs have the chance to access the medium.

FIGS. 5-6 illustrate example scenarios in which TX shortening may occur, including a PPDU bursting example and a transmit opportunity (TXOP) duration limiting example, according to some embodiments. In the example of FIG. 5, a period of bursting may be interrupted (shortened) to allow for low latency data to be transmitted, before the bursting is resumed. In the example of FIG. 6, a short TXOP may be used for (e.g., non-low latency) data transmission, which may allow a TXOP to be obtained for a (e.g., higher priority) low latency data transmission. After the low latency TXOP, the medium may again be available for contending STAs.

If the transmitter of a low latency (LL) PPDU is the TXOP holder, PPDU bursting may be sufficient to allow for transmission of the LL PPDU in a timely manner, in some embodiments. In case the other transmitter is the LL PPDU's source, limiting the TXOP duration may be useful, e.g., such that the other transmitter has a higher probability to access the medium, unless TXOP sharing is used. This may be useful for cases such as when a transition from an ongoing infrastructure link to a P2P link for LL data reception (“ongoing infra link to LL P2P link”) is needed, or when a transition from an ongoing P2P link to an infrastructure link for LL data reception (“ongoing P2P link to LL infra link”) is needed. An example of such a scenario could include if an AP is transmitting best effort (BE) traffic to a client STA, and the client STA's P2P peer has LL data for the client STA.

It may be useful to provide a framework for when to allow wireless devices to shorten TX, at least in some embodiments. As an example, as part of such a framework, it may not make sense to shorten TX if the current PPDU itself contains low latency data (e.g., data in a voice (VO) or video (VI) access category), since the ongoing transmission may also need to meet its corresponding delay bound. Thus, in some embodiments, it may be the case that only low priority PPDU (e.g., that carries BE or background (BK) traffic can be shortened for higher priority VO or VI traffic.

Such a framework could also extend to whether other STAs' PPDUs can be shortened to allow a STA to send its low latency PPDU. It may be possible that unconditionally shortening others' PPDU could break the performance of existing applications, at least in some instances. Accordingly, it may be possible that a client STA may be limited in the actions it can take to improve its low latency traffic stream(s) such that other STAs' performance is not decreased.

With such policies in place as a framework, it may be the case that a client can only try to shorten a low priority PPDU that it is transmitting or receiving. In this scenario, there may be 4 cases to be considered. A first case may include when a client is transmitting BE/BK data and needs to transmit LL data. A second case may include when a client is transmitting BE/BK data and needs to receive LL data. A third case may include when a client is receiving BE/BK data and needs to transmit LL data. A fourth case may include when a client is receiving BE/BK data and needs to receive LL data. For each such case, depending on the traffic session(s) involved (e.g., infra or P2P), there could further be 4 sub-cases.

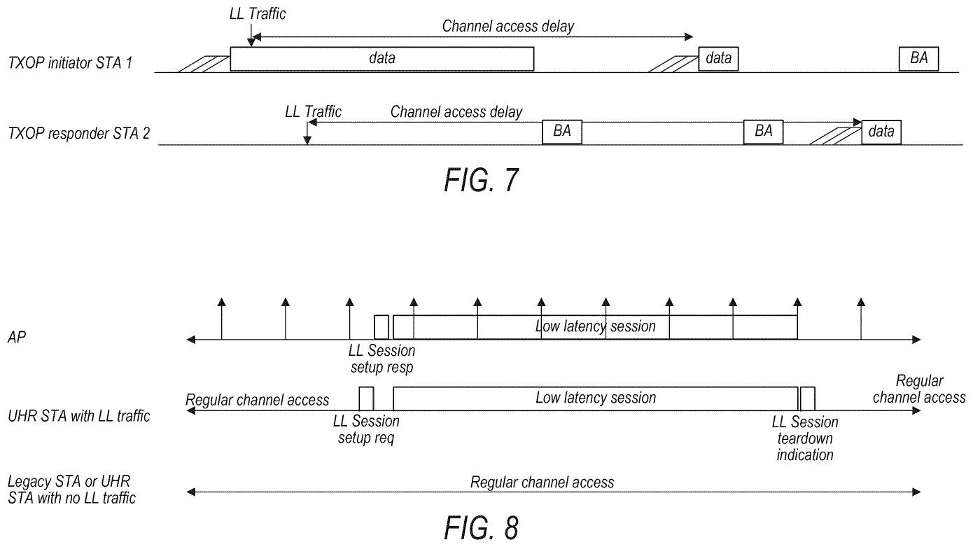

When a channel is congested or blocked by other BSS or OBSS STAs TXOP, a STA with low latency traffic may be able to use a different link (or sub-channel), in some instances. When a STA with LL traffic is engaged in transmitting or receiving non-low latency traffic, it may be necessary to wait for the TXOP to terminate to contend for channel access for the LL traffic. FIG. 7 illustrates example aspects of a such a scenario, in which a STA is subject to a channel access delay while waiting for TXOP completion, according to some embodiments. It may be desirable that an approach to addressing this scenario covers the previously noted use cases, including: when a STA needs to transmit LL traffic while transmitting non-LL traffic; when a STA needs to transmit LL traffic while receiving non-LL traffic; when a receiver needs to transmit LL traffic to a STA while the STA is transmitting non-LL traffic; and when a receiver needs to transmit LL traffic to a STA while the STA is receiving non-LL traffic. Shortening the TXOP limit to enable LL traffic access may affect the medium efficiency. It may be desirable for techniques that address this scenario to be scalable and to not degrade legacy performance, at least according to some embodiments.

One possible approach to improving handling of LL traffic in a wireless communication system may including supporting low latency sessions in Wi-Fi 8. According to some embodiments, in such an approach, a link may be shared between legacy and Wi-Fi 8 devices. When no low latency traffic is available in Wi-Fi 8 devices, “regular” channel access be used for all STAs in the system. When a Wi-Fi 8 device has low latency traffic, it may request to setup a low latency session. FIG. 8 illustrates example aspects of such low latency session setup and teardown, according to some embodiments. The LL session initiator STA may send a LL setup request frame to the LL session responder STA. This frame may include a request to setup a LL session and requested parameters for the LL session. The LL session responder STA may send a LL session setup response frame in response to the request. This frame may include the response to the request, and possibly suggested parameters, e.g., in case the request is rejected.

A Wi-Fi 8 STA with an active LL session may be able to teardown the LL session by sending a LL session teardown indication to the STA associated to it. It may be possible that the STA sending the teardown frame can be the LL session initiator STA or the LL session responder STA, in various embodiments. During the LL session, it may be the case that Wi-Fi 8 STAs with an active LL session have special channel access rules, e.g., to enable low latency traffic. Legacy devices and Wi-Fi 8 STAs with no active LL session may continue to use the regular channel access rules.

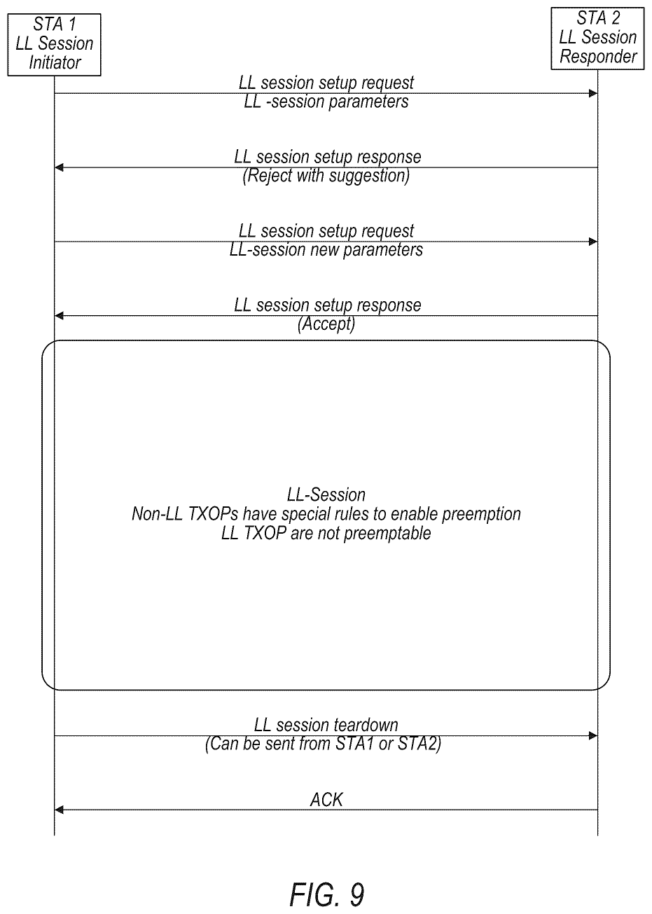

FIG. 9 is a signal flow diagram illustrating example aspects of possible LL session setup communication, according to some embodiments. When low latency data is expected between a STA and its associated STA, the STA may request to establish a LL session. The LL session initiator and LL session responder may agree to enable preemption. The STAs may exchange LL session setup request and response frames to negotiate the preemption parameters. Any non-LL TXOP in a LL session initiated by any of the STAs with an active LL session may be expected to follow the LL session rules. As noted previously, legacy devices and Wi-Fi 8 devices with no active LL session may have their channel access rules unchanged and it may be the case that a LL session does not affect those devices performance.

STAs with an active LL session may exchange LL setup frames to reach an agreement on the LL session parameters (e.g., PPDU limit, LL TIDs, whether to enable bursting, etc.). If the STAs have different LL requirements, it may be expected that the LL session parameters for both sides to be symmetric, e.g., including the PPDU target limit and other parameters in both directions, which may affect the latency of both STAs. The agreement may be made such as to satisfy the minimum requirements for both sides.

UHR STAs may switch to LL mode after receiving the LL mode response with accept to the LL channel access mode. Any non-LL TXOP initiated from a STA in the LL session may potentially be able to preempted upon TXOP initiator approval. UHR LL STAs enabling LL mode may limit their PPDU size for non-LL traffic and may allow LL traffic indication feedback from the TXOP responder. UHR TXOP initiator STAs enabling LL mode might allow sharing their TXOP with the TXOP responder when preemption is requested from the TXOP responder. UHR TXOP initiator STAs enabling LL mode might terminate their TXOP with the TXOP responder when requested by the TXOP responder.

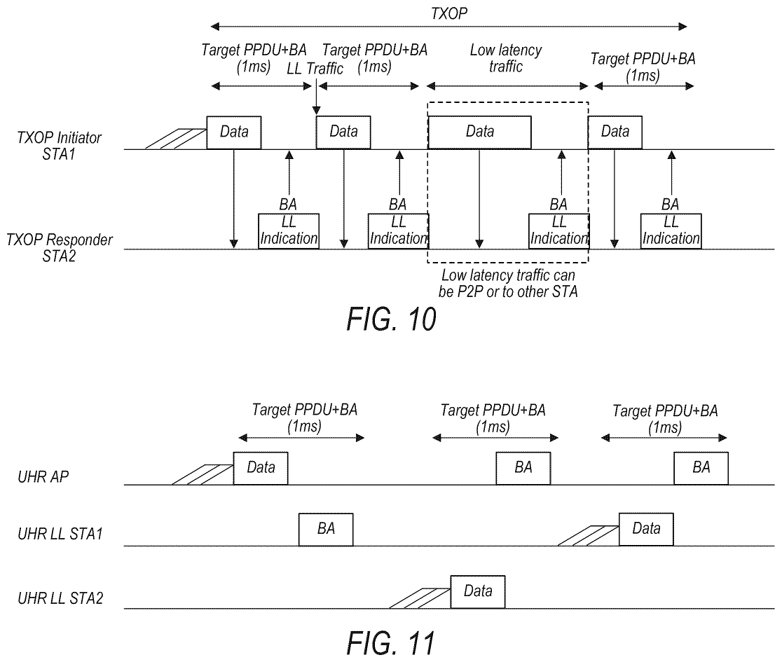

A TXOP initiator may divide a large PPDU into smaller PPDUs, e.g., with a target length determined based on a value agreed-on at the LL session setup, when transmitting non-LL traffic. For example, a target length of 1 ms, could be used, as one possibility. Other target lengths are also possible. The TXOP initiator may be able to preempt its own TXOP to transmit low latency to the TXOP responder or any other STA (e.g., via infrastructure or P2P link), at least in some instances. FIG. 10 illustrates example aspects of such a scenario, according to some embodiments. In particular, FIG. 10 illustrates aspects of an example scenario in which a TXOP initiator preempts its own TXOP to transmit low latency data to the TXOP responder. The TXOP responder may send a response frame after each PPDU with a LL traffic indication. The TXOP responder may request to preempt the on-going TXOP, and the TXOP initiator may allow preemption based on such requests. The TXOP initiator and responder may be able to agree on limiting the bursting to one PPDU to enable channel access for other STAs, in some embodiments. FIG. 11 illustrates aspects of such an example scenario, in which a TXOP bursts are each limited to one PPDU.

As noted previously, A TXOP initiator may have a target PPDU+BA duration limit that is equal to an agreed-on value at the session setup when transmitting non-LL traffic, such as 1 ms. The TXOP responder may send a LL traffic indication to the TXOP initiator in a control response frame to request preemption. Multiple types of preemption requests may be possible. As one example, a request to transmit LL traffic to the TXOP initiator in the same TXOP (e.g., LL indicator=1, as one possibility) may be included in a control response frame. As another example, a request to transmit LL traffic to a STA that is not the TXOP initiator in the same TXOP (e.g., LL indicator=2, as one possibility) may be included in a control response frame. As still another example, a request to disengage from the current TXOP (e.g., LL indicator=3, as one possibility) may be included in a control response frame. A LL indicator value (e.g., LL indicator=4, as one possibility) could be used to indicate that no request is available. As yet another example, a request for some time of the current TXOP (e.g., LL indicator=5, as one possibility) may be included in a control response frame, possibly with the duration requested also indicated in the response frame.

The TXOP initiator may respond to the TXOP responder request in any of various ways. As one possibility, the TXOP may be shared with the TXOP responder. As another possibility, the TXOP initiator may continue bursting to the TXOP responder. As a further possibility, the TXOP initiator may stop traffic to this STA in the current TXOP. As yet another possibility, the TXOP initiator may terminate the TXOP. At least according to some embodiments, it may be agreed that the TXOP initiator shall accept the reverse traffic from the TXOP responder in an active LL session. Once the TXOP responder has finished using the TXOP, it may send a control frame to return the TXOP to the TXOP initiator. The TXOP initiator may also be able to use the LL indication for future scheduling decisions.

It may be the case that any non-LL TXOP in a LL session initiated by any of the STAs with an active LL session is preemptable. A LL TXOP may be a TXOP where the primary AC is one that is tied to a TID that is defined as a LL TID. The LL TID(s) may be defined at the setup of the LL session, e.g., during the LL session setup request and response exchange. Other mechanisms can also or alternatively be used to define what is LL and non-LL traffic during a LL session, according to various embodiments.

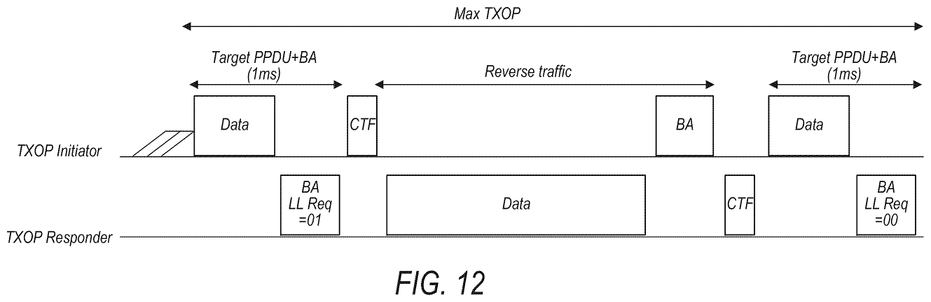

FIG. 12 illustrates example aspects of one possible scenario in which a TXOP is shared by a TXOP initiator with a TXOP responder to allow the TXOP responder to transmit LL data to the TXOP initiator in response to a request to do so from the TXOP responder. The control frame (CTF) to share a TXOP with a TXOP responder can be any of various possible frames. One possibility may include a MU-RTS TXS, if STAs are enabled to send MU-RTS TXS frames. Another possibility may include a CTS frame that is sent to the TXOP responder. A newly defined frame sent to the TXOP responder could also be used. The CTF may include an indication of the duration to be shared with the TXOP responder, for example indicating whether the duration to be shared is up to the end of the TXOP, up to the LL session PPDU target limit, or up to a duration requested by the TXOP responder, among various possibilities. Once the TXOP responder is finished using the TXOP, it may hand back what remains of the TXOP to the TXOP initiator, for example by sending a CTF to the TXOP initiator.

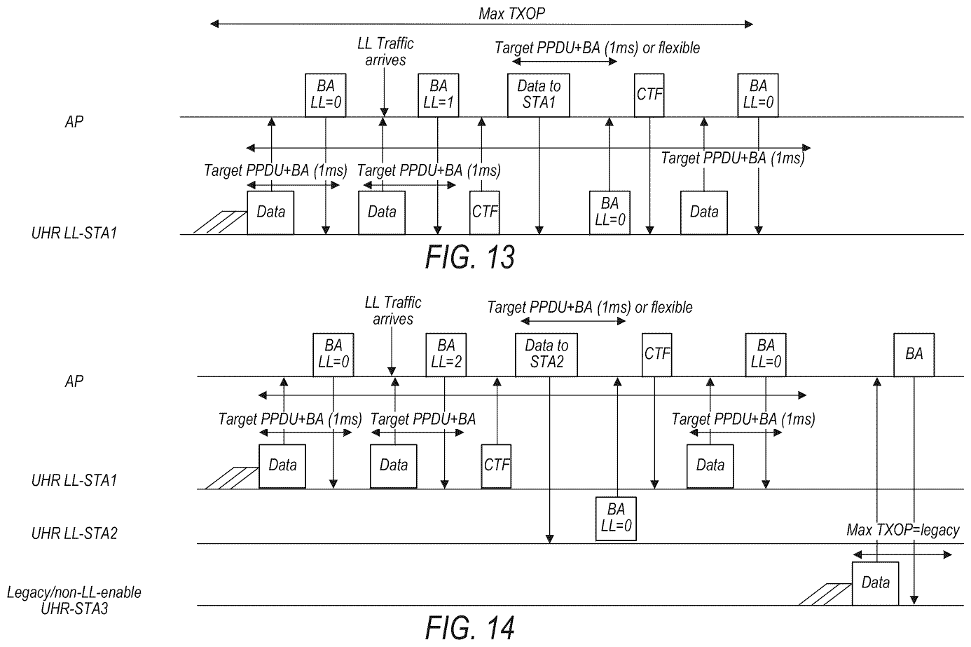

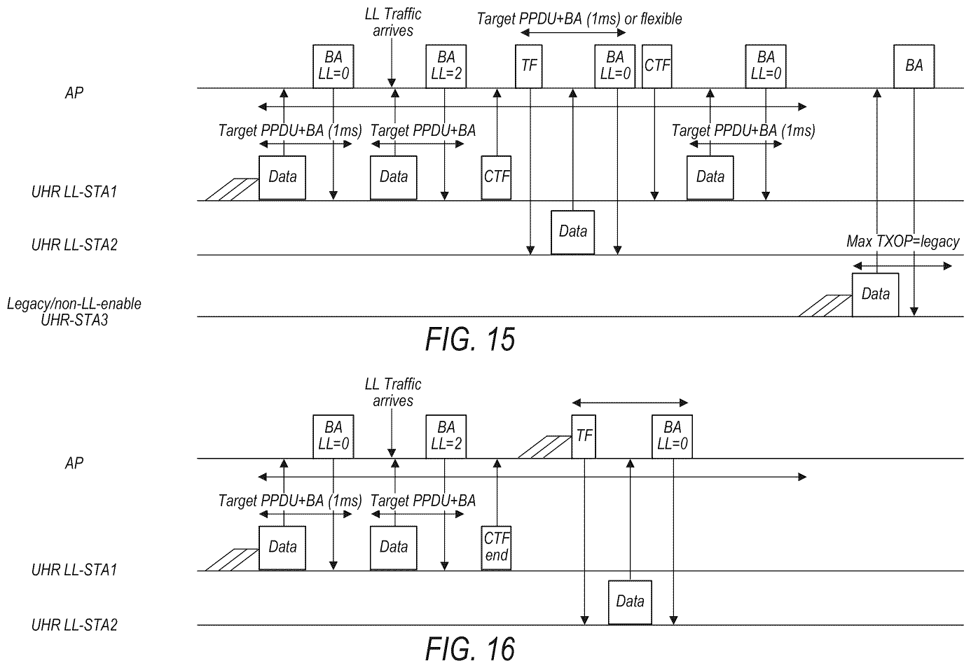

FIGS. 13-16 illustrate examples of LL session feature usage during uplink communication scenarios, according to various embodiments. In the example scenario of FIG. 13, a UHR LL STA is transmitting non-LL traffic to an AP. The AP may request to send DL LL traffic to the TXOP initiator. The UHR STA may send a control frame to enable the reverse traffic. The AP may send LL DL traffic to the UHR STA. The AP may then send a control frame to hand the rest of the TXOP to the TXOP initiator (e.g., optionally). In the example scenario of FIG. 14, a UHR LL STA 1 is transmitting non-LL traffic to an AP. The AP may request to send DL LL traffic to a different STA (“UHR STA 2”). The UHR STA 1 may send a control frame to enable the reverse traffic (alternatively, the UHR STA may terminate the TXOP). The AP may send LL DL traffic to the UHR STA 2. The AP may then send a control frame to hand the rest of the TXOP to the TXOP initiator (e.g., optionally). In the example scenario of FIG. 15, a UHR LL STA 1 is transmitting non-LL traffic to an AP. The AP may request to burst LL traffic to a different STA (“UHR STA 2”). The UHR STA 1 may send a control frame to enable the reverse traffic (alternatively, the UHR STA may terminate the TXOP). The AP may send a trigger frame (TF) to solicit LL UL traffic from the UHR STA 2. The AP may then send a control frame to hand the rest of the TXOP to the TXOP initiator after one burst of UL traffic (e.g., optionally). In the example scenario of FIG. 16, a UHR LL STA 1 is transmitting non-LL traffic to an AP. The AP may request to burst LL traffic to a different STA (“UHR STA 2”). The UHR STA 1 may terminate the TXOP. The AP may contend for medium control to send a TF to solicit LL UL traffic from the UHR STA 2 (or to send DL traffic). It may thus be possible to enable LL DL traffic to interrupt UL non-LL transmission, to enable an AP to trigger UL traffic for other STAs if LL traffic characteristic is known to the AP during a non-LL TXOP, and/or to enable LL DL traffic to be scheduled after a UL LL transmission, at least according to some embodiments.

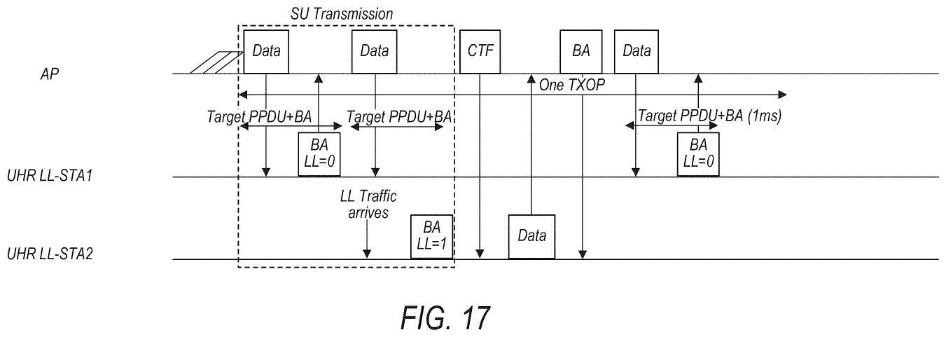

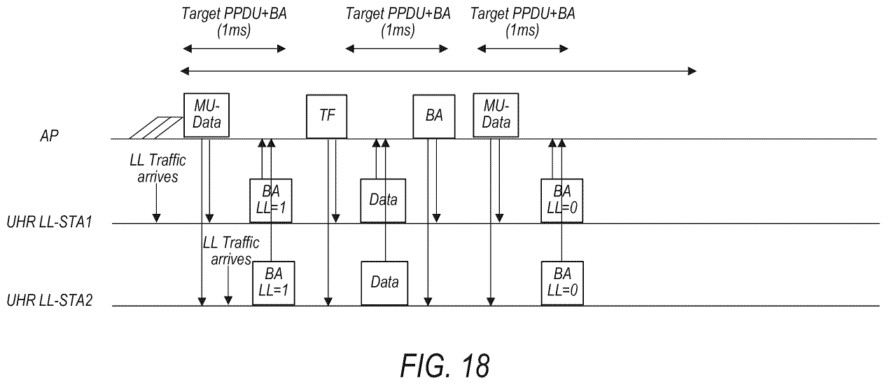

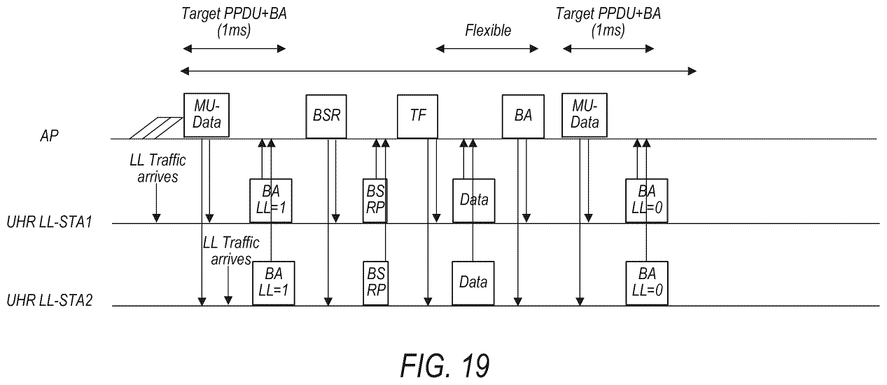

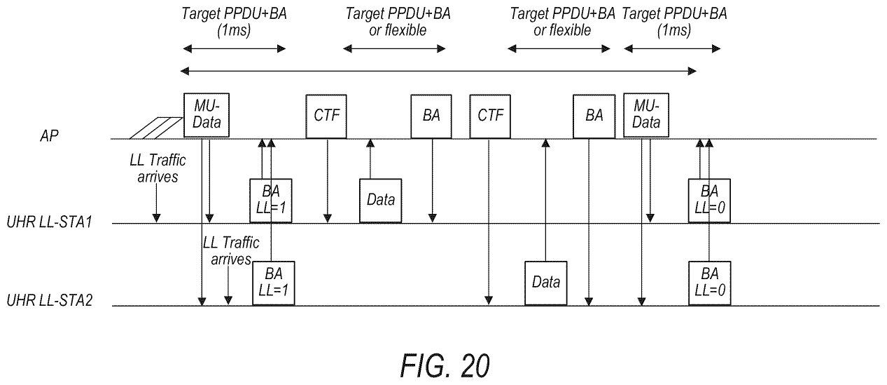

FIGS. 17-20 illustrate examples of LL session feature usage during downlink communication scenarios, according to various embodiments. In the example scenario of FIG. 17, an AP sends single user (SU) DL non-LL data and receives a BA with LL request from one of the STAs. The AP may send a CTF for the requesting STA, and may terminate the TXOP or continue the burst based on the feedback. The AP may also be able to send LL DL traffic to another STA during the TXOP. In the example scenarios of FIGS. 18-19, an AP sends multi user (MU) DL non-LL data and receives a BA with LL requests from the STAs. The AP can schedule a TF for the requesting STA(s), terminate the TXOP, or continue the burst based on the feedback. The AP may trigger the STAs requesting LL UL transmission for a predefined burst of data, where the time for the TB PPDU can be one PPDU with a target burst size, or a duration equal to the time left for the TXOP, among various possibilities. If the AP knows the UL traffic characteristics it may adjust the resource allocation for the known traffic. As shown in FIG. 19, in some instances, the AP may send a buffer status report poll (BSRP) to get the status of the buffers at the requesting STAs, based on which the AP may trigger the uplink transmission with resources selected accordingly. In the example scenario of FIGS. 20, an AP sends multi user (MU) DL non-LL data and receives a BA with LL requests from the STAs. The AP may provide CTF transmissions to the requesting STAs in sequence (or may terminate the TXOP or continue the burst) based on the feedback. Each CTF may solicit one PPDU transmission with a target PPDU length, e.g., as agreed upon. It may thus be possible to enable LL UL traffic to interrupt non-LL DL transmission, and/or to enable LL DL traffic to interrupt non-LL DL transmission to other STAs, at least according to some embodiments.

In some embodiments, it may be agreed that an AP scheduling MU-DL or MU-UL PPDU with multiple STAs, when one or more of them has an active LL session, shall adjust the PPDU duration limit to be the minimum of the required PPDU duration limit of all STAs with active LL sessions involved in the transmission. The AP may enable preempting by any of the STAs receiving the MU-DL that have an active LL session. The AP may have the opportunity to send DL LL traffic after scheduling MU-UL with PPDU limit, e.g., if needed. The STA may be able to send LL data if it receives a TF from the AP for any access category. It may be the case that the AP does not follow the PPDU limit for a MU-DL PPDU when no STA with active LL session is scheduled in the MU-DL frame.

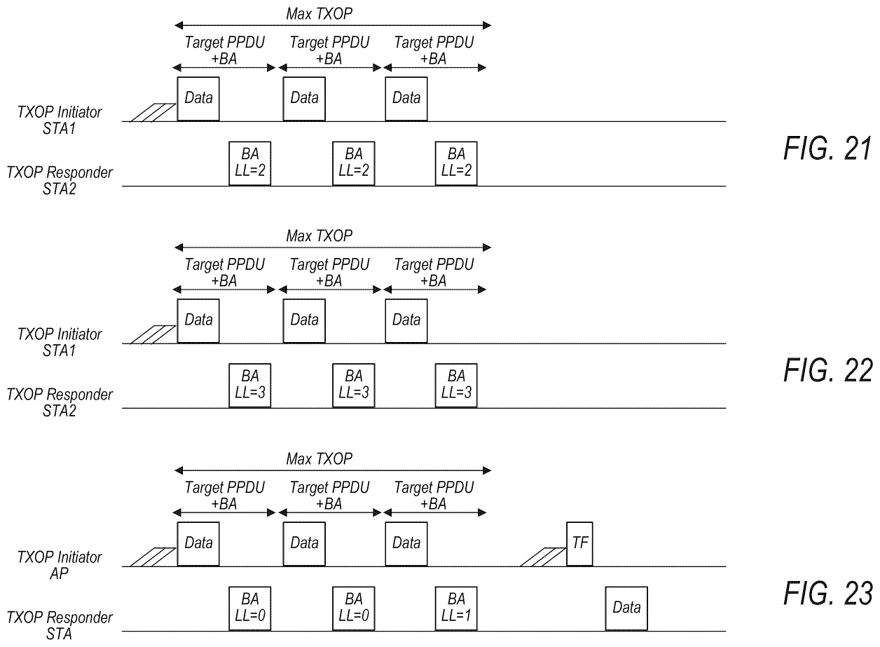

It may be the case that a TXOP initiator can choose to reject a preemption request from a TXOP responder. FIGS. 21-23 illustrate example aspects of various such possible scenarios, according to some embodiments. In the example scenario of FIG. 21, the TXOP responder may request to use the TXOP to communicate with another STA. The TXOP responder may, for example, be an AP and need to transmit LL traffic to a different STA than the TXOP initiator, or the TXOP responder may be a non-AP STA and need to transmit LL traffic to a peer STA that is not the TXOP initiator (AP). As another possibility, as illustrated in the example scenario of FIG. 22, the TXOP responder may request to terminate the TXOP and the TXOP initiator may decide to continue the transmission. As another possibility, the TXOP initiator may be able to choose to reject a request, but take it into consideration for future scheduling. The TXOP responder may also be able to send feedback to the TXOP initiator at the end of the TXOP, e.g., to inform the initiator of pending LL traffic on the responder side, as illustrated in the example scenario of FIG. 23. An AP receiving a TXOP preemption request from a STA at the end of the TXOP may use this information to send a TF in a further TXOP.

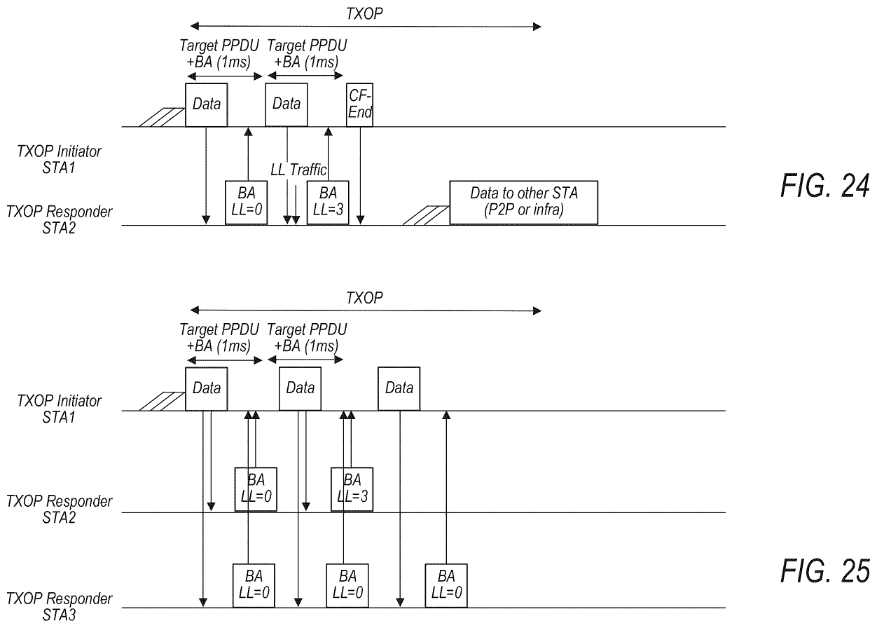

FIGS. 24-25 illustrate example aspects of possible scenarios in which a STA requests TXOP disengagement, according to some embodiments. In such scenarios, the TXOP responder may need to switch channels for infrastructure traffic on another link or P2P traffic, or may need to start a new TXOP to another STA other than the TXOP initiator. The TXOP responder may request in the feedback frame to stop transmitting to it during this TXOP and to end the data bursting. As shown in the scenario of FIG. 24, the TXOP initiator can accept such a request and terminate the TXOP. The TXOP responder may get a chance to contend and obtain channel access for data transmission, or switch to another channel. As shown in the scenario of FIG. 25, it may also be possible for the TXOP initiator to continue using the TXOP (e.g., with one or more other users), and not send or allocate resources to the TXOP responder that requested to stop traffic.

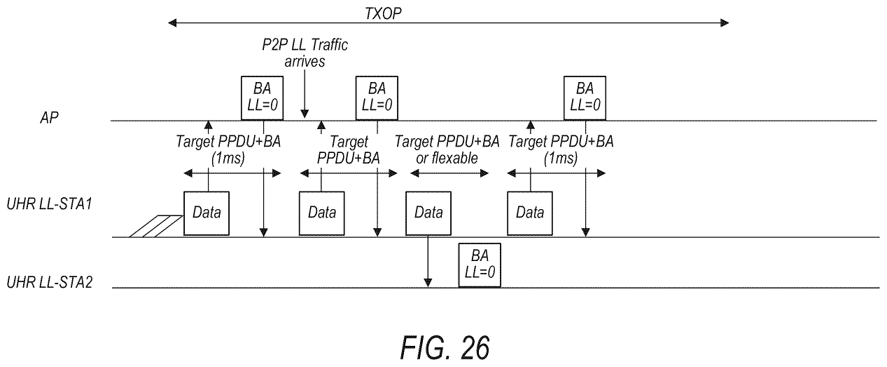

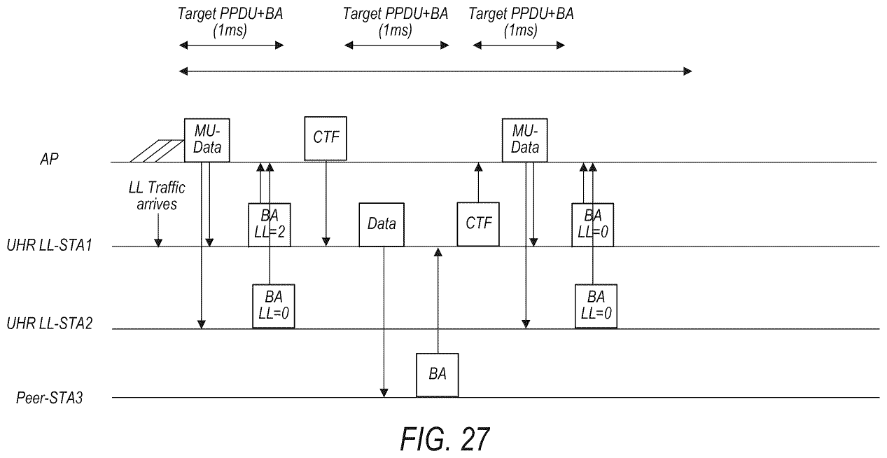

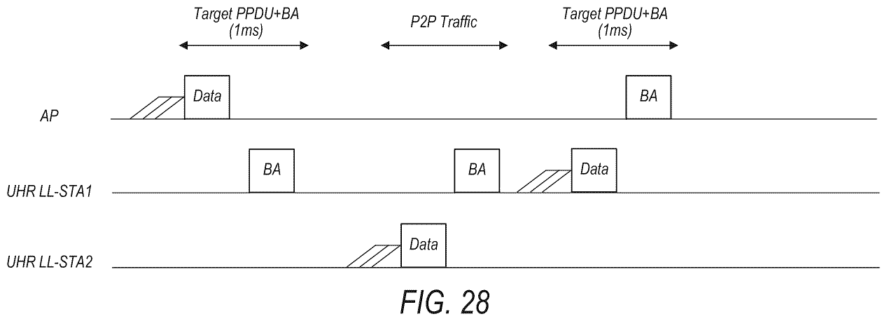

FIGS. 26-28 illustrate example aspects of possible scenarios in which TXOP preemption for P2P communication is used, according to some embodiments. In the example scenario of FIG. 26, UL traffic may be preempted for P2P data. As shown, a STA may have a non-LL TXOP to an AP with a LL session. The STA may preempt its own non-LL TXOP to send P2P data to a peer STA in the same TXOP. The STA may resume UL traffic after it is finished with the P2P traffic, e.g., if time still remains in the TXOP. In the example scenario of FIG. 27, DL traffic may be preempted for P2P data. As shown, an AP may have a non-LL TXOP to a STA with a LL session. The STA may provide a request to the AP to preempt the TXOP to send data to another STA. If the AP accepts the request, the AP may send a CTF (e.g., MU-RTS TXS or any of various other possible frames) to grant the TXOP to the STA requesting the preemption. The requesting STA may use the TXOP for the P2P data. Once the requesting STA is finished with the P2P data exchange, it may return the TXOP to the AP again, e.g., if time still remains in the TXOP, by sending a control frame to the AP. In some embodiments, the TXOP initiator and responder can agree on limiting the bursting to one PPDU to enable channel access for other STAs. This may limit the TXOP length to STAs requesting LL sessions, such as in the illustrated scenario of FIG. 28, e.g., so that other (e.g., P2P) devices may not be blocked from transmitting to these STAs.

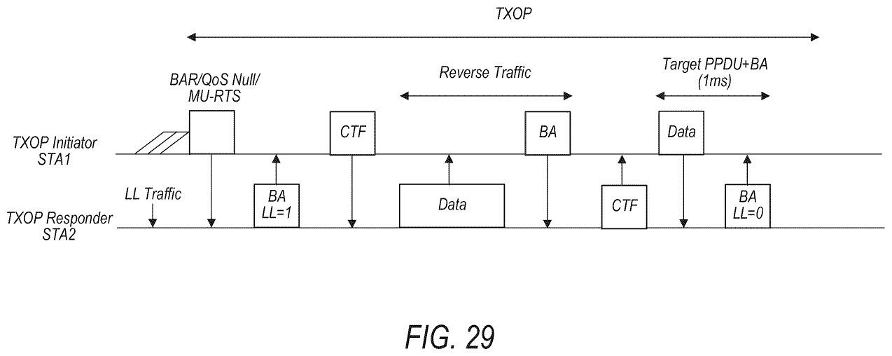

In some embodiments, a STA (e.g., an AP or non-AP STA) can enable preemption at the beginning of the TXOP. An ICF to solicit the BA with preemption indication can be used at the beginning of the TXOP in such cases. FIG. 29 illustrates aspects of one possible example scenario in which this approach can be used. As shown, the STA can send a BAR at the beginning of the TXOP to solicit a BA with LL indication, and the STA can decide to continue with the TXOP or share the TXOP with the TXOP responder. As another possibility, a AP/STA can send a MU-RTS or any other ICF indicating that it is expecting to receive a BA in response with LL indication, and the AP can decide to continue with the TXOP or share the TXOP with the TXOP responder. The STA can also potentially send a QoS Null frame to solicit a BA with a LL indication. Still another possibility can include using a buffer status report poll (BSRP) as an ICF to solicit a preemption indication. In some instances, the STA can reuse the same mechanism to solicit DL traffic when a hidden node is blocking the DL traffic from the STA side; the STA can contend for channel access and send a BAR to the AP (optionally to start with RTS/CTS, at least in some instances), the AP can indicate in the BA if LL data is available, and the STA can share the TXOP with the AP if it determines to do so. After any such TXOP sharing, the TXOP initiator can proceed with transmitting the target PPDU and receiving the corresponding BA.

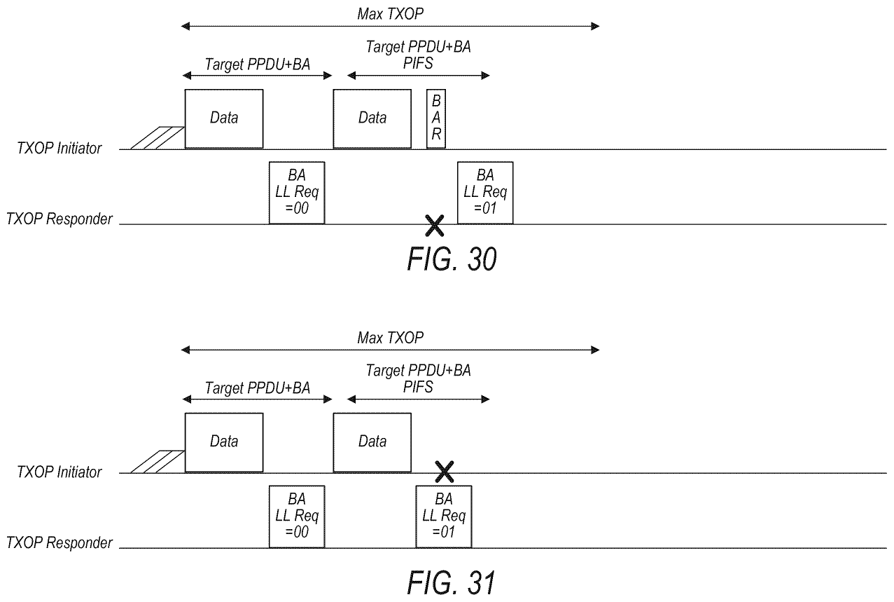

It may be useful, at least in some instances, to define behavior for scenarios in which BA feedback is not received. FIGS. 30-31 illustrate example aspects of such possible scenarios, according to some embodiments. In the example scenario of FIG. 30, if a BA is not received by a TXOP initiator (e.g., not transmitted by the TXOP responder), the TXOP initiator may perform point interframe space (PIFS) recovery and send a BA request (BAR) to solicit a BA from the TXOP responder, and the burst duration may be extended to target PPDU+BAR+BA. Alternatively, the TXOP initiator may terminate the TXOP. In the illustrated scenario of FIG. 31, the BA may not be received by the TXOP initiator due to interference or collision. In this case, it may be the case that the TXOP is not able to do PIFS recovery, e.g., since the medium may be busy. The TXOP responder may accordingly not receive a control frame indicating to transmit LL data, and may contend to access the channel.

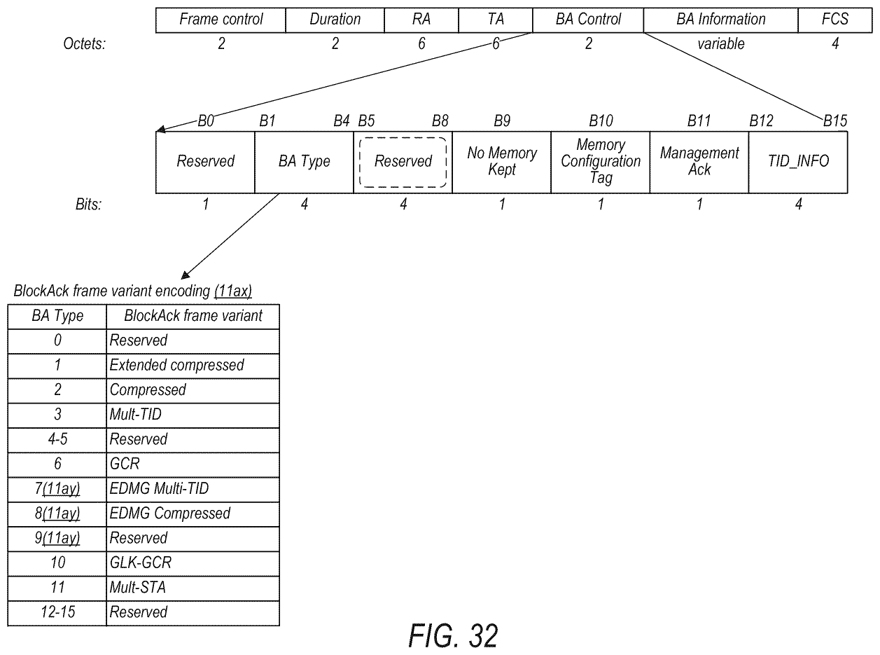

The TXOP responder may provide the LL feedback to the TXOP initiator in a response control frame, such as a BA frame. The TXOP responder might need 2 or more bits to add the various request options. The TXOP responder may additionally add the duration of the TXOP needed, at least in some embodiments, which could for example use 1 octet, at least as one possibility. FIG. 32 illustrates example aspects of one possible update to a BA frame format to support such feedback, according to some embodiments. The reserved bits in the BA control field could be used, for example, to provide 2 bits of LL feedback. As another possibility, one of the predefined BA frame variants (e.g., Multi-STA BA, as one possibility) could be reused. As a still further possibility, a new type of BA could be defined, e.g., with a specified number of bits for LL feedback and duration request in addition to the BA information. The TXOP responder could also use a new response control frame, which could have the LL feedback information included. As a further possibility, the TXOP responder could aggregate the LL feedback (e.g., in QoS null frame, or HT control, as some possibilities) information to the BA in an aggregated media access control protocol data unit (AMPDU).

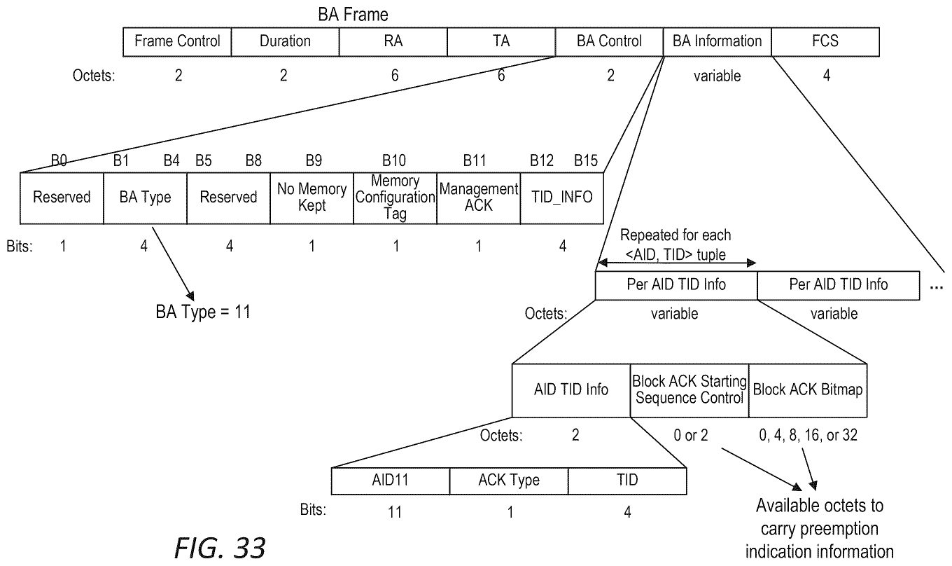

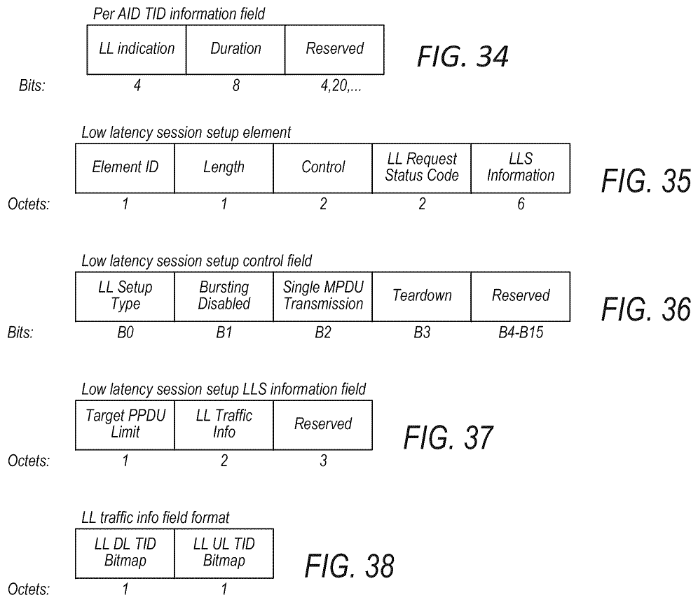

FIG. 33 illustrates example aspects of a possible multi-STA BA frame that could be used to carry additional control information, e.g., other than BA bitmap information to acknowledge A-MPDU(s) and/or MPDU(s). For example, such indication information can be sent in the M-STA BA frame to provide a low latency preemption indication. As shown, the BA frame can be reused with BA type (11) indicated as multi-STA BA. A new per-AID info field can be used to add the indication information. The AID11 field can use a special value to indicate that it carries a preemption indication and/or otherwise carries non-BA bitmap information. The AID11 field can use the peer STA AID. The ACK type and TID combination can be selected to indicate that it carries a preemption indication. Some or all of the remainder of the fields in the per AID TID info field can be used to carry the preemption indication information. As a further example, FIG. 34 illustrates example aspects of such a per-AID TID info field that could be used to carry preemption indication information. In the illustrated example, the LL indication can carry different feedback sent from the TXOP responder to the TXOP initiator. Duration can carry the duration requested for preemption. The rest of the subfield can be reserved for future use.

FIGS. 35-38 illustrate example aspects of possible LL session setup and teardown frame element formats, according to some embodiments. According to the illustrated frame formats, a new low latency session setup action frame may be used to carry a low latency session setup element. The low latency session setup element fields may include an element ID and length field, which may be defined per IEEE 802.11 baseline. A LL setup request field, if set to 1, may indicate that this element is for a LL setup request sent by the LL setup initiator, and if set to 0, may indicate that this element is for LL setup response sent by the LL setup responder. Bursting disabled may be set to 0 if PPDU bursting is enabled during the TXOP, otherwise only one PPDU with the target length may be allowed (e.g., PPDU bursting may be disabled). Single MPDU transmission may be set to 1 if 1 MPDU transmission is enabled when it exceeds the agreed target PPDU size. This can also be set by default without negotiation, in some embodiments. Teardown may be set to 1 by the LL setup initiator or responder if the LL session is to be terminated. All other fields may be reserved when this field is set to 1, in some embodiments. Otherwise, this field may be set to 0. The LL request status code may contain the result of the LL setup request, and may include one of the status codes specified in the IEEE 802.11 baseline. This field may be reserved when the element is contained in a LL setup request. When the status code is REJECTED_WITH_SUGGESTED_CHANGES, the LL setup responder may fill the other element fields with suggested values to accept a future request. The target PPDU limit field may be specified as an unsigned integer, in units of 32 μs max size request. It may indicate the target for the PPDU limit when non-LL traffic is transmitted between the two STAs. The LL DL TID bitmap and LL UL TID bitmap subfields may specify the TID(s) that are identified by the STA requesting the LL session as latency sensitive traffic streams in the downlink and uplink directions. A value of 1 at bit position k in either bitmap may indicate that TID k is classified as a latency sensitive traffic stream for the direction to which the bitmap corresponds. A value of 0 at bit position k in either bitmap may indicate that TID k is not classified as a latency sensitive traffic stream for the direction to which the bitmap corresponds.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
performing, by a first wireless device with a second wireless device, low latency session setup that establishes one or more low latency session parameters for a low latency session between the first wireless device and the second wireless device.

2. The method of claim 1, wherein the method further comprises, by the first wireless device:
preempting, based at least in part on the low latency session between the first wireless device and the second wireless device, an ongoing transmission of lower priority traffic to start transmission or reception of low latency traffic, wherein the first wireless device is either the transmitter or receiver of the ongoing transmission.

3. The method of claim 1, wherein the low latency session setup further comprises:
a low latency session setup request and response exchange, including an accept indication associated with a low latency session setup request.

4. The method of claim 1, wherein the low latency session setup further comprises:
a low latency session setup request and response exchange, including a rejection of a low latency session setup request that indicates a suggested low latency session parameter that differs from one or more low latency session parameters indicated in the low latency session setup request.

5. The method of claim 1,
wherein the one or more latency session parameters established for the low latency session include one or more of:
one or more traffic identifiers (TIDs) that are associated with latency sensitive uplink or downlink traffic streams for the low latency session;
a target physical layer protocol data unit (PPDU) length limit for non-low latency traffic during the low latency session; or
an indicator of whether physical layer protocol data unit (PPDU) bursting of non-low latency traffic during a transmit opportunity (TXOP) is enabled during the low latency session.

6. The method of claim 1, wherein the method further comprises:
performing, by the first wireless device with the second wireless device during a transmit opportunity (TXOP), an initial control frame and control response frame exchange and/or a non-low latency data frame and control response frame exchange, wherein the control response frame includes a low latency traffic indication.

7. The method of claim 6, wherein the low latency traffic indication indicates:
a request to transmit low latency traffic to a wireless device that is a TXOP initiator in the TXOP;
a request to transmit low latency traffic to a wireless device that is not the TXOP initiator in the TXOP;
a request to disengage from the TXOP;
a request for an amount of time of the TXOP; or
no low latency request.

8. The method of claim 6,
wherein the control response frame that includes the low latency traffic indication comprises a multi-station (M-STA) block acknowledgement (BA) frame, wherein a per association identifier (AID) traffic identifier (TID) information field of the M-STA BA frame includes low latency traffic indication information.

9. The method of claim 1, wherein the method further comprises, subsequent to establishing the low latency session:
performing low latency session teardown for the low latency session between the first wireless device and the second wireless device.

10. A first wireless device, comprising:
one or more antennas;
a radio operably coupled to the one or more antennas; and
a processor operably coupled to the radio;
wherein the first wireless device is configured to:
transmit, to a second wireless device, a first low latency session request comprising an indication of one or more low latency session parameters for a low latency session; and
receive, from the second wireless device, a first low latency session response for the low latency session.

11. The first wireless device of claim 10, wherein the one or more low latency session parameters include one or more of:
one or more traffic identifiers (TIDs) that are associated with latency sensitive uplink or downlink traffic streams for the low latency session;
a target physical layer protocol data unit (PPDU) length limit for non-low latency traffic during the low latency session; or
an indicator of whether physical layer protocol data unit (PPDU) bursting of non-low latency traffic during a transmit opportunity (TXOP) is enabled during the low latency session.

12. The first wireless device of claim 10,
wherein the first low latency session setup response includes an indication that the first low latency session setup request is rejected with a suggested change,
wherein the first low latency session setup response includes an indication of a suggested low latency session parameter that differs from one or more low latency session parameters indicated in the first low latency session setup request.

13. The first wireless device of claim 12, wherein the first wireless device is further configured to:
select one or more low latency session parameters for a second low latency session setup request based at least in part on the suggested low latency session parameter indicated in the first low latency session setup response, wherein at least one low latency session parameter differs between the first low latency session setup request and the second low latency session setup request;
transmit, to the second wireless device, the second low latency session setup request; and
receive, from the second wireless device, a second low latency session setup response for the low latency session.

14. The first wireless device of claim 10, wherein the first wireless device is further configured to:
initiate a transmit opportunity (TXOP) with the second wireless device;
transmit a non-low latency data frame during the TXOP;
receive a control response frame during the TXOP that includes a low latency traffic indication;
determine to share the TXOP based at least in part on the low latency traffic indication; and
transmit a control frame indicating a duration of the TXOP that is shared with the second wireless device.

15. An apparatus comprising processing circuitry and memory, the memory configured to cause the processing circuitry to:
receive low latency session request signaling comprising an indication of one or more low latency session parameters for a low latency session between a first wireless device and a second wireless device; and
generate low latency session response signaling associated with the low latency session.

16. The apparatus of claim 15, wherein the one or more low latency session parameters include one or more of:
one or more traffic identifiers (TIDs) that are associated with latency sensitive uplink or downlink traffic streams for the low latency session;
a target physical layer protocol data unit (PPDU) length limit for non-low latency traffic during the low latency session; or
an indicator of whether PPDU bursting of non-low latency traffic during a transmit opportunity (TXOP) is enabled during the low latency session.

17. The apparatus of claim 15, wherein the memory is further configured to cause the processing circuitry to:
receive a non-low latency data frame during a transmit opportunity (TXOP) during the low latency session; and
generate control response frame signaling that includes a low latency traffic indication.

18. The apparatus of claim 17, wherein the low latency traffic indication indicates:
a request to transmit low latency traffic to a TXOP initiator in the TXOP;
a request to transmit low latency traffic to a wireless device that is not the TXOP initiator in the TXOP;
a request to disengage from the TXOP;
a request for an amount of time of the TXOP; or
no low latency request.

19. The apparatus of claim 17, wherein the memory is further configured to cause the processing circuitry to:
receive a control frame indicating TXOP sharing; and
generate a low latency data frame configured for communication during a duration of the TXOP that is shared.

20. The apparatus of claim 19, wherein the memory is further configured to cause the processing circuitry to:
generate control frame signaling that includes an indication of return of the TXOP after the duration of the TXOP that is shared.
